(19) United States
(12) Patent Application Publication
(10) Pub. No.: US 2012/0265429 A1
(43) Pub. Date: Oct. 18, 2012

(54) SYSTEMS AND METHODS OF MONITORING FUEL CONSUMPTION IN AN ENVIRONMENTAL-CONTROL UNIT

(76) Inventors: Halnettige K. Perera, Huntersville, NC (US); Ulrich Fink, Maple Grove, MN (US); Timothy A. Walker, Plymouth, MN (US)

(21) Appl. No.: 13/088,151

(22) Filed: Apr. 15, 2011

(51) Int. Cl. G06F 19/00

(52) U.S. Cl. 701/123

(57) ABSTRACT

A system for determining a fuel consumption of a transportable environmental-control unit. The system includes a sensor and a controller. The sensor is configured to sense an amount of fuel in a tank. The controller is configured to receive an indication of the amount of fuel in the tank from the sensor, monitor and filter the indication of the amount of fuel received from the sensor for a first period of time, monitor and filter the indication of the amount of fuel received from the sensor for a second period of time, and determine a quantity of fuel used between an end of the first period of time and an end of the second period of time.

### BACKGROUND

The invention relates to systems and methods for determining fuel consumption of a transportable refrigerated unit.

Present transportable environmental-control units (e.g., refrigerated trailers, refrigerated containers, etc.) generally include containers that are cooled by refrigeration systems powered by a diesel engine. These environmental-control units provide an indication of fuel remaining in a fuel tank, but do not provide any additional fuel related data.

### SUMMARY

In one embodiment, the invention provides a system for determining a fuel consumption of a transportable environmental-control unit. The system includes a sensor and a controller. The sensor is configured to sense an amount of fuel in a tank. The controller is configured to receive an indication of the amount of fuel in the tank from the sensor, monitor and filter the indication of the amount of fuel received from the sensor for a first period of time, monitor and filter the indication of the amount of fuel received from the sensor for a second period of time, and determine a quantity of fuel used between an end of the first period of time and an end of the second period of time.

In another embodiment the invention provides a transportable environmental-control unit. The unit includes a container, an environment control system, a generator, an engine, a fuel tank, and a controller. The environment control system is configured to cool an environment of the container. The generator is configured to power the environment control system. The engine is configured to drive the generator. The fuel tank is configured to provide fuel to power the engine. The sensor is configured to sense an amount of fuel in the fuel tank. The controller is configured to receive an indication of the amount of fuel in the fuel tank from the sensor, monitor and filter the indication of the amount of fuel received from the sensor for a first period of time, monitor and filter the indication of the amount of fuel received from the sensor for a second period of time, and determine a quantity of fuel used between an end of the first period of time and an end of the second period of time.

In another embodiment the invention provides a method of monitoring fuel used by a transportable environmental-control unit. The method includes sensing an amount of fuel in a tank, filtering the sensed amount of fuel over a first time period to obtain a first filtered amount of fuel, storing the first filtered amount of fuel, filtering the sensed amount of fuel over a second time period to obtain a second filtered amount of fuel, comparing the first filtered amount of fuel to the second filtered amount of fuel, and determining a quantity of fuel used between an end of the first time period and an end of the second time period.

Other aspects of the invention will become apparent by consideration of the detailed description and accompanying drawings.

### BRIEF DESCRIPTION OF THE DRAWINGS

FIG. 1 is a block diagram of an environmental-control unit.

FIG. 2 is a flow chart of an initial fuel level determination process.

FIGS. 3A and 3B are a flow chart of an operational fuel level determination process.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Transportable environmental-control units (e.g., refrigerated trailers, refrigerated containers, etc.) generally include containers that are cooled by refrigeration systems powered by a diesel engine. Tracking the consumption of the fuel used by the engine would enable analysis of the fuel consumption to improve system performance, perform maintenance in a timely manner, charge customers based on actual fuel consumption, receive tax benefits, etc.

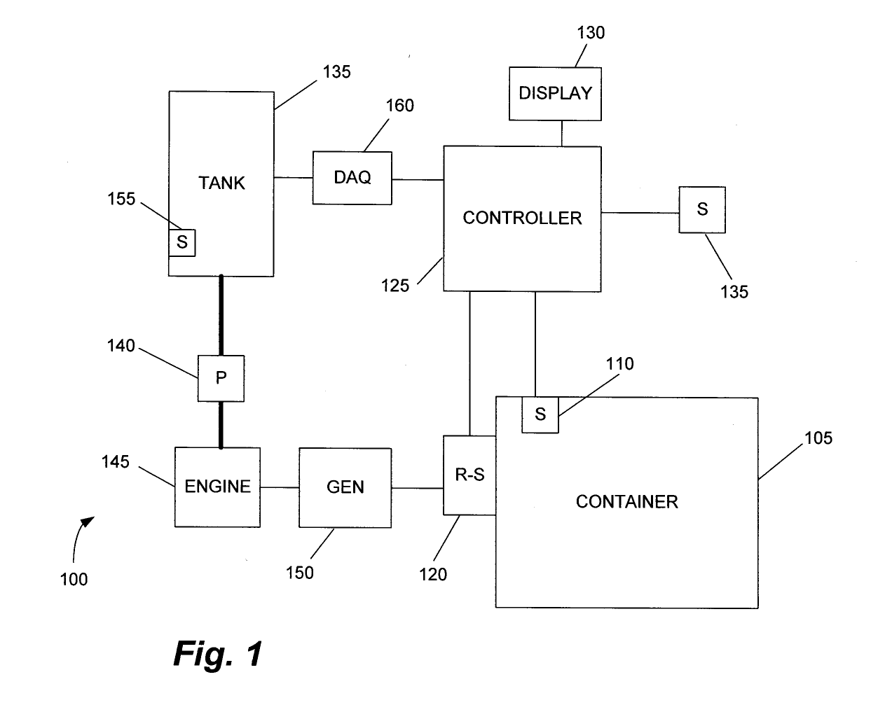

FIG. 1 shows a block diagram of a construction of a transportable refrigeration unit 100 incorporating an embodiment of the invention. While the invention is described in connection with a transportable refrigeration unit, it is envisioned that the invention can be used in other transportable environmental-control units. These units can control one or more of the following environmental parameters: temperature, humidity, pressure, light, sound, etc.

The unit 100 includes a container 105, a first temperature sensor 110, a second temperature sensor 115, a refrigeration system 120, a controller 125, a display 130, a fuel tank 135, a fuel pump 140, an engine 145, a generator 150, a fuel sensor 155, and a data acquisition system 120 (e.g., such as systems available from Agilent Technologies, Inc. of Santa Clara, Calif.). The first temperature sensor 110 is positioned inside the container 105, and senses the temperature inside the container 105. The second temperature sensor 115 is positioned so that it can sense ambient air temperature outside the container 105.

The controller 125 receives an indication of the temperature inside the container 105 from the first temperature sensor 110. The controller 125 operates the refrigeration system 120 to maintain the temperature inside the container 105 around a set point temperature. The refrigeration system 120 can also control other elements of the container's environment such as humidity. The set point temperature is set at a level based on the cargo stored inside the container 105. The engine 145 drives the generator 150, which powers the refrigeration system 120. In some constructions, the engine 145 can operate in a continuous mode or in an on-demand mode. In the on-demand mode, the engine 145 is off unless the refrigeration system 120 is operating to cool the container 105.

In the construction shown, the data acquisition system 120 receives a signal from the fuel sensor 155 indicative of the level of fuel or the quantity of fuel in the tank 135, and converts the signal into a signal (e.g., analog or digital) compatible with the controller 125. In other constructions, the controller 125 receives the signal directly from the fuel sensor 155. The fuel sensor 155 can be a float sensor, an ultrasonic level sensor, or other sensor capable of detecting a depth or volume of fuel in the fuel tank 135.

The controller 125 includes a processor (e.g., a microprocessor, microcontroller, ASIC, DSP, etc.), memory (e.g., flash, ROM, RAM, EEPROM, etc.), which can be internal to the controller 125, external to the controller 125, or a combination thereof, and input/output circuitry. The display 130 provides information about the fuel in the tank 135 to a user, and can be an LCD display, one or more LEDs, an analog meter, etc., or a combination thereof.

Fuel tanks 135 generally come in one of two configurations: rectangular or cylindrical. A float-type fuel sensor 155 provides an indication of the level of the fuel in the tank 135. Based on the configuration of the tank 135, different calculations need to be made to determine the quantity of fuel in the tank 135 or the amount of fuel used during a time period.

To determine the amount of fuel used during a time period for a rectangular tank 135 having a float-type fuel sensor 155, a first fuel level x is determined at a first time T₀. Following the time period, at time T₁, a second fuel level y is determined. In one implementation, the determined fuel levels are percentages of the total tank 135 capacity. In other implementations, other level measurements can be used (e.g., inches). In addition, a plurality of measurements are averaged and/or filtered in determining the first and second fuel levels x and y. The equations below are used for determining the amount of fuel consumed between T₀ and T₁. In some implementations, a look-up table is used to determine the fuel consumption.

Percent of fuel consumed(FC%)=x%−y% (eq. 1)

Quantity consumed(QFC)=(FC%/100)×Tank capacity(gallons or liters) (eq. 2)

The rate of fuel consumption can then be determined using:

Rate=QFC/Δt (eq. 3)

where Δt=T₁−T₀ (eq. 4)

To determine the amount of fuel used during a time period for a cylindrical tank 135 having a float-level type fuel sensor 155, a first fuel level x is determined (e.g., by filtering and/or averaging multiple sensor 155 readings) at a first time T₀. Following the time period, at time T₁, a second fuel level y is determined (e.g., by filtering and/or averaging multiple sensor 155 readings). In one implementation, the determined fuel levels are percentages of the total tank 135 capacity. In other implementations, other level measurements can be used (e.g., inches). The equations below are used for determining the amount of fuel consumed between T₀ and T₁. In some implementations, a look-up table is used to determine the fuel consumption. The fuel levels at times T₀ and T₁ are then calculated using:

Fuel level x(“zx”)=(2r)*x% (eq. 5)

Fuel level y(“zy”)=(2r)*y% (eq. 6)

where: r=the radius of the tank 135.

The volume of fuel at times T₀ and T₁ are then calculated using:

$$\begin{matrix}V ( zx ) = length \times ( ( {r}^{2} \times ( {cos}^{- 1} \times ( 1 - \frac{zx}{r} ) ) ) + ( ( zx - r ) \times \sqrt{( ( 2 r \times zx ) - {zx}^{2} )} & ( eq . 7 ) \\ V ( zy ) = length \times ( ( {r}^{2} \times ( {cos}^{- 1} \times ( 1 - \frac{zy}{r} ) ) ) + ( ( zx - r ) \times \sqrt{( ( 2 r \times zy ) - {zy}^{2} )} & ( eq . 8 )\end{matrix}$$

The fuel consumed and the rate of consumption are then calculated using:

Fuel consumed(gallons/liters)=[V(zx)−V(zy)] (eq. 9)

Rate of Fuel consumption=[V(zx)−V(zy)]/[Δt] (eq. 10)

Some ultra-sonic type fuel sensors 155 provide a volume indication (i.e., V(x) and V(y)). Accordingly, for such sensors 155, only equations 9 and 10 are needed to determine the fuel consumed and the rate of fuel consumption for such an ultra-sonic type fuel sensor 155.

In some constructions, the controller 125 determines that the state is normal when the rate of fuel consumption is in the range of about 0.5 gallons per hour (gph) to about 1.0 gph. The controller 125 determines that the state is refueling (e.g., a possible event relating to the replenishment of fuel in the tank 135) when the determined second fuel level y % is greater than the determined first fuel level x %, and the rate of change is about 500 gph (this is an EPA regulated rate). The controller 125 determines that the state is fuel theft (e.g., a possible event related to the theft of fuel from the tank 135) when the rate of fuel consumption (x % is greater than y %) is about −80 to 200 gph (based on a 12 VDC pump). Individual implementations of the invention can chose cut-off points between these rates to switch the determination of the state from one state to another (e.g., 50 gph can be the transition point between the normal and refueling states).

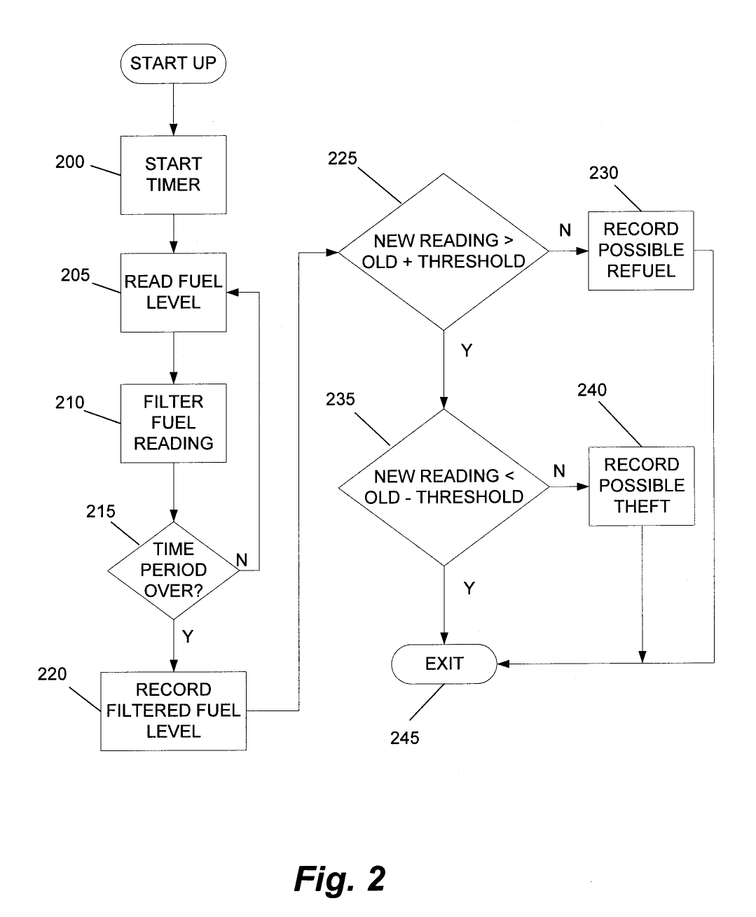

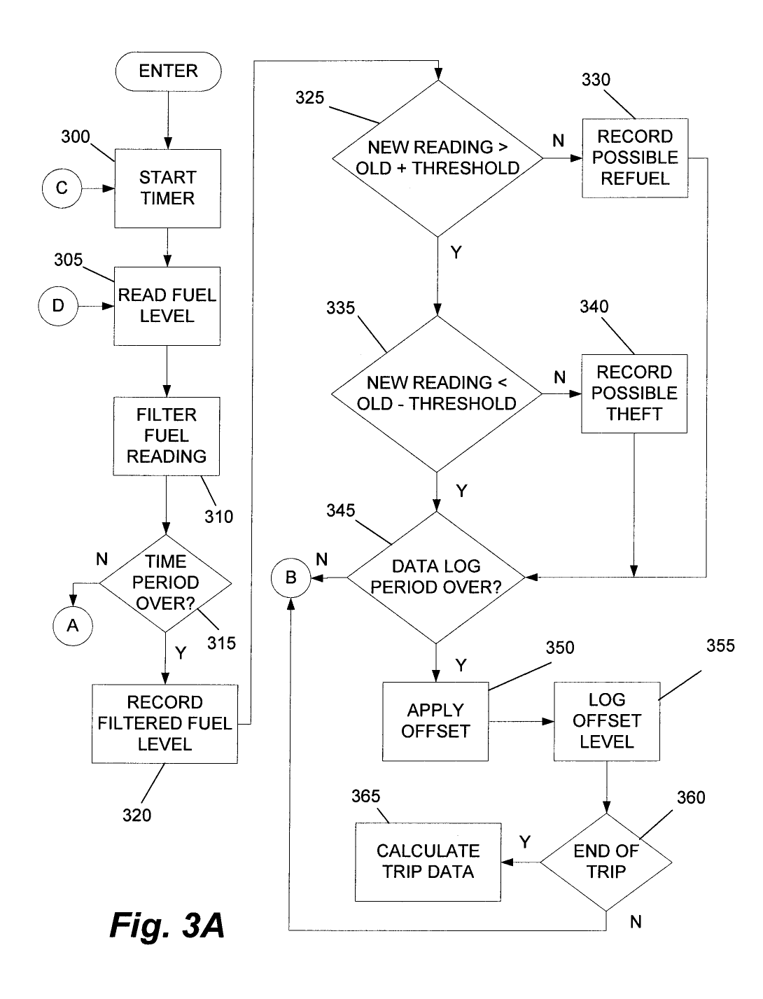

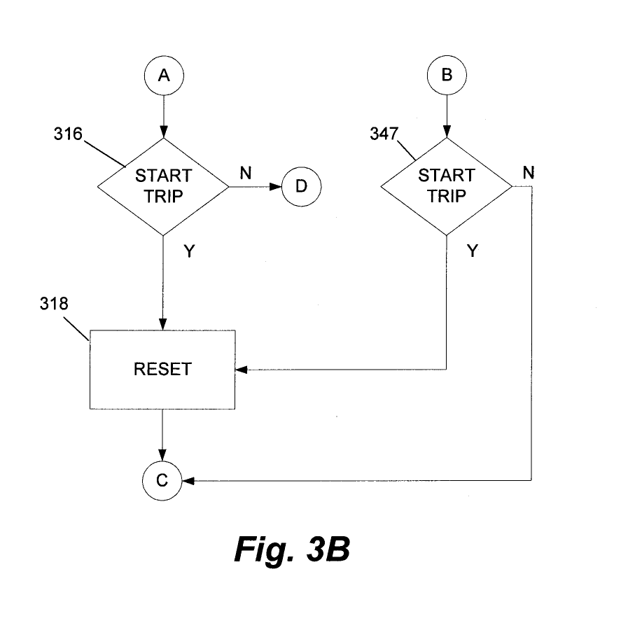

FIGS. 2 and 3 show an embodiment of a process for determining the fuel consumption of the environmental-control unit 100.

FIG. 2 shows an initial start-up process. Upon initial start-up of the engine 145, a timer is started (step 200). The controller 125 then reads (i.e., monitors) the fuel level from the fuel sensor 155 for a time period (e.g., two minutes) (step 205). In order to account for noise in the signal from the sensor 155, caused by, for example, movement of the fuel in the tank (e.g., sloshing due to movement of the environmental-control unit 100), the environmental-control unit 100 being on a slant (e.g., driving up a hill), etc., readings from the sensor 155 are filtered (step 210). Filtering methods can include averaging and Gaussian distribution, among others. The controller 125 determines if the time period is complete (step 215). If not, the fuel level continues to be read (step 205) and filtered (step 210). Once the time period is complete (step 215), the filtered fuel level is recorded with a time stamp (step 220).

Next, the controller 125 compares the fuel level at the end of the initial time period to a reading prior to the engine being previously turned off. If the new reading is greater than the previous reading by more than a threshold (e.g., fifteen percent) (step 225), the controller 125 logs a possible refueling event in a data log (step 230). If the new reading was not more than the threshold greater than the previous reading, the controller 125 determines if the new reading is less than the previous reading by more than a second threshold (e.g., fifteen percent) (step 235). If the new reading is more than the second threshold less than the previous reading, the controller 125 logs a possible fuel theft event (step 240). If the new reading was not more than the second threshold less than the previous reading (step 235), or following logging a possible refueling event (step 230), or logging a possible fuel theft event (step 240), the controller 125 exits the initial start-up process (step 245).

FIGS. 3A and 3B show a continuing operation process. The process starts with starting a timer (step 300). The controller 125 then reads the fuel level from the fuel sensor 155 for a time period (e.g., two minutes) (step 305). In order to account for noise in the signal from the sensor 155, caused by, for example, movement of the fuel in the tank (e.g., sloshing due to movement of the environmental-control unit 100), the environmental-control unit 100 being on a slant (e.g., driving up a hill), etc., readings from the sensor 155 are filtered (step 310). Filtering methods can include averaging and Gaussian distribution, among others. The controller 125 determines if the time period is complete (step 315). If not, the controller 125 checks if a start of trip function has been triggered (step 316, FIG. 3B). The start of trip function can be triggered by a button on a user interface or other suitable input (e.g., a wireless signal from a smartphone, etc.). If the start of trip function was not triggered, the fuel level continues to be read (step 305) and filtered (step 310).

If the start of trip function was triggered, the controller 125 enters a reset function which resets the data, timers, etc. so that fuel consumption for a trip can be recorded and calculated (step 318), and restarts the process at step 300 (start timer).

Once the time period is complete (step 315), the filtered fuel level is recorded with a time stamp (step 320). Next the controller 125 checks if a quantity of readings (e.g., six) is more than a threshold (e.g., fifteen percent) greater than a reading prior to the quantity of readings (step 325). If so, a possible refueling event is logged in the data log (step 330).

If a possible refueling event is not detected (step 325), the controller 125 checks if a quantity of readings (e.g., six) is more than a second threshold (e.g., fifteen percent) less than a reading prior to the quantity of readings (step 335). If so, a possible fuel theft event is logged in the data log (step 340).

If a possible fuel theft event is not detected (step 330) or a possible refueling event has been logged (step 330) or a possible theft event has been logged (step 340), the controller 125 determines if a data-logging time period (e.g., four hours) has passed since the last data log occurred (other than possible refueling or fuel theft events) (step 345). In addition to checking if the data logging period has passed, the controller 125 also determines at step 345 if an end of trip function has been triggered. The end of trip function can triggered by the same input as the start of trip function discussed above or can be a separate input.

If neither the data logging period has passed nor the end of trip function has been triggered, the controller 125 checks if the start of trip function has been triggered (step 347, FIG. 3B). If the start of trip function was not triggered, the process repeats (step 305).

If the start of trip function was triggered, the controller 125 enters the reset function which resets the data, timers, etc. so that fuel consumption for a trip can be recorded and calculated (step 318), and restarts the process at step 300 (start timer).

If the data-logging time period has elapsed or the end of trip function was triggered (step 345), the controller 125 determines if an offset should be applied to the reading (step 350). In some implementations, when the reading is 60% to 100% full, the offset is zero, when the reading is 20% to 60% full, the offset is −3.0 gallons, and when the reading is less than 20% full, the offset is −3.5 gallons. The distribution brackets are used for float-level type sensors, and are chosen based on empirical and analytical derivations, and are used to account for increased sloshing of the fuel in the tank, and vibration of the tank, causing fluctuations in the fuel level readings. The distribution brackets increase in magnitude as the fuel level decreases.

The offset reading is then logged into the data log with a time stamp (step 355). In some embodiments, the actual reading is logged as well as the offset reading. Next the controller 125 checks if the end of trip function has been triggered (step 360). If not, the controller 125 checks if the start of trip function has been triggered (step 347, FIG. 3B). If the start of trip function was not triggered, the process repeats (step 300).

If the start of trip function was triggered, the controller 125 enters the reset function which resets the data, timers, etc. so that fuel consumption for a trip can be recorded and calculated (step 318), and restarts the process at step 300 (start timer).

If the end of trip function has been triggered, trip data (e.g., fuel consumed, beginning fuel level, ending fuel level, start time, end time, distance traveled, etc.) is calculated and logged (step 365). In some embodiments, a hard copy document of the trip data may be printed.

In some implementations, two or more data logs are maintained. For example, an environmental-control unit having a continuous operating mode and an on-demand operating mode has a separate data log for each mode. When the mode is switched, the process restarts at step 200 with the initial start-up process (FIG. 2).

The controller 125 uses the data in the data log to provide information to an operator of the environmental-control unit 100. For example, the controller 125 can calculate an average run time remaining until the fuel will run out, and can display this value on the display 130, along with the actual fuel level. In some implementations, the controller 125 can light an LED when the time remaining drops below a threshold (e.g., four hours). The data log can also include other parameters such as, ambient temperature, temperature set point, etc. Data in the data log can be uploaded to a remote device (e.g., a computer) and used to evaluate/improve operating conditions, charge customers for fuel actually used, etc.

Various features and advantages of the invention are set forth in the following claims.

What is claimed is:

1. A system for determining a fuel consumption of a transportable environmental-control unit, the system comprising:
a sensor configured to sense an amount of fuel in a tank; and
a controller configured to
receive an indication of the amount of fuel in the tank from the sensor,
monitor and filter the indication of the amount of fuel received from the sensor for a first period of time,
monitor and filter the indication of the amount of fuel received from the sensor for a second period of time, and
determine a quantity of fuel used between an end of the first period of time and an end of the second period of time.

2. The system of claim 1, wherein the controller determines an amount of time until the fuel will run out.

3. The system of claim 2, further comprising a display, the controller displaying the amount of time until the fuel will run out on the display.

4. The system of claim 1, wherein the controller is configured to determine that a possible refueling event has occurred.

5. The system of claim 1, wherein the controller is configured to determine that a possible fuel theft has occurred.

6. The system of claim 1, wherein the sensor is a float-type sensor.

7. The system of claim 1, wherein the sensor is an ultra-sonic sensor.

8. A transportable environmental-control unit, the unit comprising:
a container;
an environment control system configured to cool an environment of the container;
a generator configured to power the environment control system;
an engine configured to drive the generator;
a fuel tank configured to provide fuel to power the engine;
a sensor configured to sense an amount of fuel in the fuel tank; and
a controller configured to
receive an indication of the amount of fuel in the fuel tank from the sensor,
monitor and filter the indication of the amount of fuel received from the sensor for a first period of time,
monitor and filter the indication of the amount of fuel received from the sensor for a second period of time, and
determine a quantity of fuel used between an end of the first period of time and an end of the second period of time.

9. The unit of claim 8, wherein the controller determines an amount of time until the fuel will run out.

10. The unit of claim 9, further comprising a display, the controller displaying the amount of time until the fuel will run out on the display.

11. The unit of claim 8, wherein the controller is configured to determine that a possible refueling event has occurred.

12. The unit of claim 8, wherein the controller is configured to determine that a possible fuel theft has occurred.

13. A method of monitoring fuel used by a transportable environmental-control unit, the method comprising:
sensing an amount of fuel in a tank;
filtering the sensed amount of fuel over a first time period to obtain a first filtered amount of fuel;
storing the first filtered amount of fuel;
filtering the sensed amount of fuel over a second time period to obtain a second filtered amount of fuel;
comparing the first filtered amount of fuel to the second filtered amount of fuel; and
determining a quantity of fuel used between an end of the first time period and an end of the second time period.

14. The method of claim 13, further comprising determining an amount of time until the fuel will run out.

15. The method of claim 14, further comprising displaying the amount of time until the fuel will run out on a display.

16. The method of claim 13, further comprising determining that a possible refueling event has occurred, and logging an indication of the possible refueling event including a time and a date.

17. The method of claim 13, further comprising determining that a possible fuel theft has occurred, and logging an indication of the possible fuel theft including a time and a date.

18. The method of claim 13, further comprising logging the filtered quantity of fuel after a third period of time.

19. The method of claim 18, further comprising communicating the logged data to a remote device.

20. The method of claim 19, further comprising logging additional parameters of the environmental-control unit, and communicating the additional parameters to the remote device.
